(19) United States
(12) Patent Application Publication
(10) Pub. No.: US 2007/0038457 A1
(43) Pub. Date: Feb. 15, 2007

(54) Method and apparatus for extending sound input and output

(75) Inventors: Kwang-il Hwang, Suwon-si (KR); Kwon-ju Yi, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/482,050

(22) Filed: Jul. 7, 2006

(30) Foreign Application Priority Data
Aug. 12, 2005 (KR) 10-2005-0074419

(51) Int. Cl. G10L 21/00

(52) U.S. Cl. 704/270

(57) ABSTRACT

A method and apparatus for extending sound input and output. The apparatus includes an input unit which receives a sound, a codec which converts the sound into a digital signal and converts the digital signal into a sound signal, an output unit which outputs the sound signal via second speaker units, a control unit which processes the sound signal, and an interface unit which is connected to a mobile device via a data communication interface and transmits the sound signal processed by the control unit to the mobile device and receives the sound signal processed by the control unit from the mobile device, both under the control of the control unit. The input unit includes first speaker units which are incorporated in the mobile device and output a sound generated by the mobile device, a receiver which outputs an incoming-call sound, a first microphone which is installed inside the mobile device and receives a user's voice signal, and a second microphone which is installed outside the mobile device and receives a background sound.

### CROSS-REFERENCE TO RELATED APPLICATION

This application claims priority from Korean Patent Application No. 10-2005-0074419 filed on Aug. 12, 2005 in the Korean Intellectual Property Office, the disclosure of which is incorporated herein by reference.

### BACKGROUND OF THE INVENTION

1. Field of the Invention

The present invention relates to a method and apparatus for extending sound input and output, and, more particularly, to sound input and output extending method that can simultaneously process a user's voice, a background sound and sounds generated via multiple paths from the mobile device itself using a controller operating independently of the mobile device, and output specific sounds as the processing results.

2. Description of Related Art

Conventional sound input/output extension techniques, which are disclosed in Korean Published Application No. 2004-0039517 entitled “Handset Having Noise Measurement Function and Method of Manufacturing the Same,” and Korean Published Application No. 2003-0060365 entitled “Voice Recognition Hands-Free System and Method of Operating the Same,” are described with reference to FIGS. 1A and 1B.

FIG. 1A is a block diagram of a conventional handset having a noise measurement function. Referring to FIG. 1A, the conventional handset includes a noise measurement module which measures noise and a circuit module which determines an output level of a speaker according to the result of the measurement. A microphone 1 receives external noise and converts the noise into a voltage signal. A pre-amplifier 2 amplifies the voltage signal provided by the microphone 1. Thereafter, a noise detection unit 3 detects a root mean square (RMS) value and a peak value from the amplified voltage signal provided by the pre-amplifier 2. A mobile station modem (MSM) 4 converts the RMS value and the peak value provided by the noise detection unit 3 to a predetermined unit of measurement upon the request of a user. A key input unit 7 permits a user to input the request. Thereafter, the MSM 4 converts the resulting RMS value and peak value into an image signal, and outputs the image signal to a liquid crystal display (LCD) 6. Also, the MSM 4 generates a voice level control signal based on the converted RMS value and the converted peak value, and outputs the voice level control signal to a speaker unit 5. The speaker unit 5 receives the voice level control signal from the MSM 4 and adjusts an output level according to the voice level control signal.

The microphone 1, which is used for receiving external noises, processes sounds generated by a mobile phone, sounds generated by a user while making a phone call, or background sounds and senses them all as noise. Therefore, in order for the microphone 1 to effectively measure noise, a user and his or her mobile phone should not produce unnecessary noise.

FIG. 1B is a block diagram of a conventional voice recognition hands-free system 10 which converts the user's voice into a digital signal, compares the digital signal with previously-stored data, and transmits the results of the comparison as text to a mobile phone via a communication port.

Referring to FIG. 1B, a microphone receives a user's voice signal, amplifies the voice signal, and outputs the amplified voice signal. A codec 11 converts the amplified voice signal into a digital signal. A voice recognition engine 14 recognizes the digital signal as the voice the user, converts the result of the recognition into data having a predefined format, and outputs the data. A data conversion unit 12 is provided with name information by a processor 15, and converts the name information into data having the same format as the data output by the voice recognition engine 14. The data provided by the data conversion unit 12 is stored in a data storage unit 13 by the processor 15. Here, the name information provided by the processor 15 is part of phone number information stored in a mobile phone 20. A connection port 16 is a communication port which enables the hands-free system 10 and the mobile phone 20 to communicate. The processor 15 transmits the name information to the data conversion unit 12, and controls the data conversion unit 12 to convert the name information into data having the same format as the data output by the voice recognition engine 14. Also, the processor 15 receives the data output by the voice recognition engine 14, determines whether a match for the received data exists in the data storage unit 13 by searching through data stored in the data storage unit 13, and transmits data for making a phone call to the mobile phone 20 according to the results of the determination.

The hands-free system 10 uses the microphone and the processor 15 to perform voice recognition. However, since the hands-free system 10 does not include a speaker, voice data cannot be output, and additional sound processing operations cannot be performed.

### BRIEF SUMMARY

An aspect of the present invention provides a sound input and output extending method, in which a controller is used independently of whether a mobile device is being operated. Accordingly, the sound input and output extending method enables a user's voice, background sounds and sounds generated by the mobile device itself via multiple paths to be simultaneously processed, and outputs specific sounds as the processing results without affecting nor being affected by operations of the mobile device.

According to an aspect of the present invention, there is provided a sound input and output extending apparatus including: an input unit that receives a sound; a codec that converts the sound into a digital signal and converts the digital signal into a sound signal; an output unit that outputs the sound signal via speaker units; a control unit that processes the sound signal; and an interface unit that is connected to a mobile device via a data communication interface and transmits the processed sound signal to the mobile device and receives the processed sound signal, both under the control of the control unit. The input unit includes first speaker units in the mobile device, and that output a sound generated by the mobile device, a receiver which outputs an incoming-call sound, a first microphone in the mobile device and that receives a user's voice signal, and a second microphone outside the mobile device and receives a background sound.

According to another aspect of the present invention, there is provided a method of extending sound input and output in an apparatus in which a plurality of modes are settable and which is connected to a mobile device that is switchable between each of the plurality of modes, the method including: receiving from the mobile device information regarding a mode status of the mobile device; receiving and measuring an outgoing-call sound received through a first microphone, an incoming-call sound that is output by a receiver, a background sound that is received via a second microphone, and a sound that is generated by the mobile device and output by first speaker units according to the received information regarding the mode status of the mobile device; and adaptively controlling the outgoing-call sound, the incoming-call sound, the background sound, and the first speaker sound according to the received information regarding the mode status based on the measured result.

According to still another aspect of the present invention, there is provided a method of extending sound input and output in a sound extending apparatus connected to a mobile device which outputs sounds via first speaker units, the method including: receiving a command to initiate a multi-sound function from the mobile device; measuring a first speaker sound output by the mobile device, searching for a sound which can be output together with the first speaker sound; and choosing the found sound, and outputting the chosen sound together with the first speaker sound.

According to a further aspect of the present invention, there is provided a method of extending sound input and output in an apparatus in which a plurality of modes are settable and which is connected to a mobile device that is switchable between each of the plurality of modes, the method including: measuring an outgoing-call sound received through a first microphone, a first speaker sound generated by the mobile device, and a background sound received through a second microphone; determining whether an emergency condition has occurred based on the measured result; transmitting data regarding the outgoing-call sound, the first speaker sound, and the background sound and a wakeup signal for the mobile device to the mobile device, when it is determined that the emergency condition has occurred; and causing the mobile device to output a signal indicating that the emergency condition has occurred.

According to other aspects of the present invention, there are provided computer-readable storage media encoded processing instructions for causing a processor to execute the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1A is a block diagram of a conventional handset having a noise measurement function;

FIG. 1B is a block diagram of a conventional voice recognition hands-free system;

FIG. 2 is a block diagram of a sound input and output extending apparatus according to an embodiment of the present invention and a mobile device to which the apparatus is connected;

FIG. 3 is a flowchart of a method of extending sound input and output according to an embodiment of the present invention;

FIGS. 4A through 4D are flow diagrams illustrating a control procedure in the method of extending sound input and output according to an embodiment of the present invention;

FIG. 5 is a flowchart illustrating a method of extending sound input and output according to another embodiment of the present invention; and

FIG. 6 is a flowchart illustrating a method of extending sound input and output according to another embodiment of the present invention.

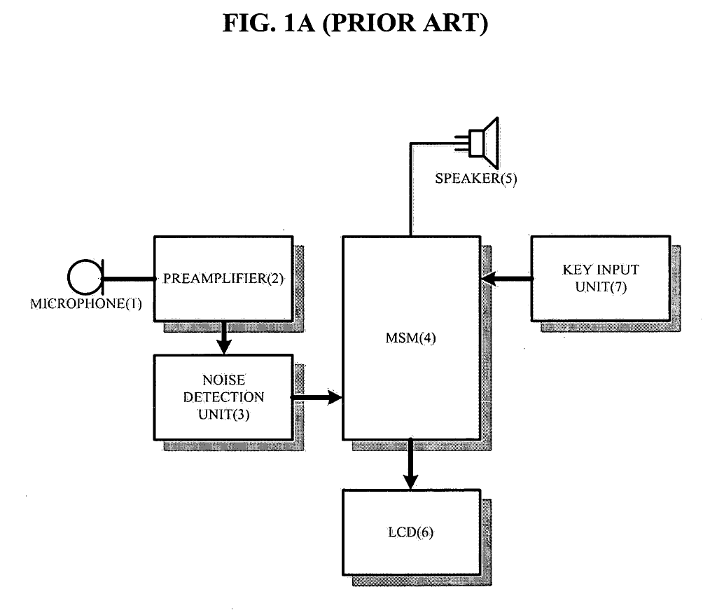

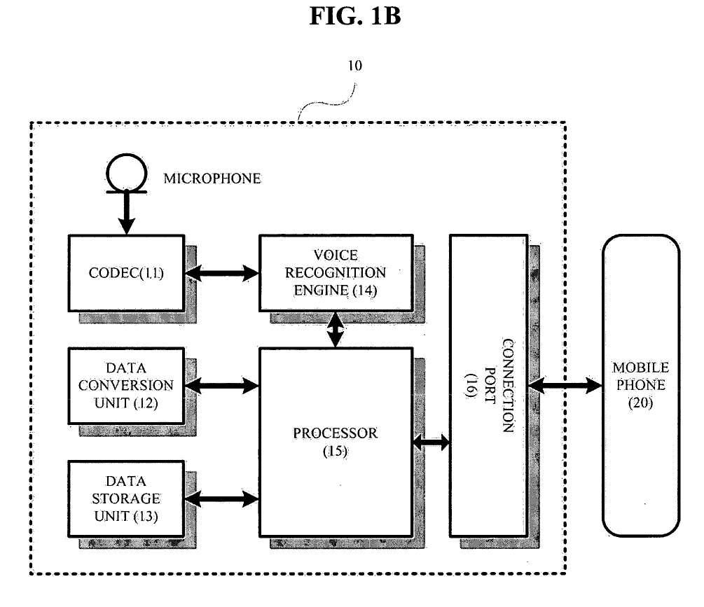

### DETAILED DESCRIPTION OF EMBODIMENTS

Reference will now be made in detail to embodiments of the present invention, examples of which are illustrated in the accompanying drawings, wherein like reference numerals refer to the like elements throughout. The embodiments are described below in order to explain the present invention by referring to the figures.

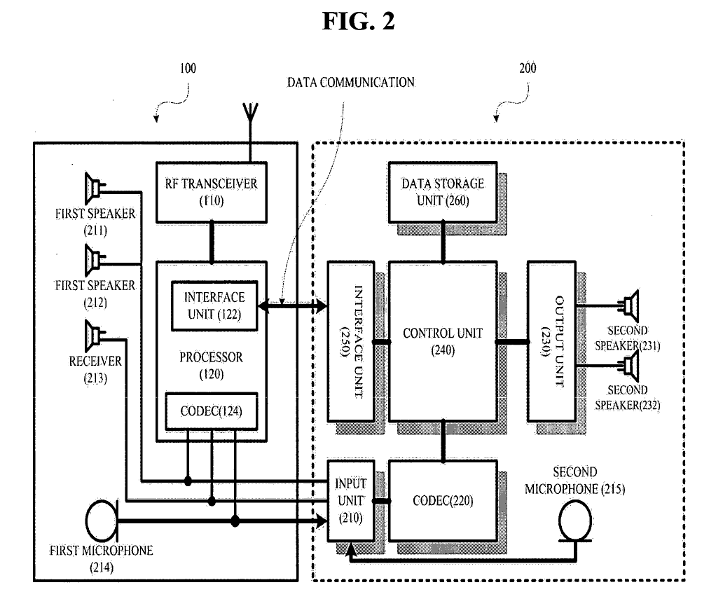

FIG. 2 is a block diagram of a sound and output extending apparatus 200 according to an embodiment of the present invention and a mobile device to which the apparatus is connected. A configuration in which the sound and output extending apparatus 200 according to an embodiment of the present invention and a mobile device 100 are connected to the sound and output extending apparatus 200 is described in detail with reference to FIG. 2.

The mobile device 100 includes a radio frequency (RF) transceiver 110 which transmits and receives RF signals via an antenna, an interface unit 122 which is connected to the sound input and output extending apparatus 200, a processor 120 which includes a codec 124 that converts analog signals into digital signals, first speaker units 211 and 212, a receiver 213, and a first microphone 214. The mobile device 100 is connected to and assists the sound input and output extending apparatus 200. Since the configuration of the mobile device 100 of the present invention is substantially similar to a device of the conventional art, a detailed description thereof has been omitted.

The sound input and output extending apparatus 200 includes an input unit 210, a codec 220, an output unit 230, a control unit 240, an interface unit 250, and a data storage unit 260.

The input unit 210 receives a sound and inputs the sound to the sound input and output extending apparatus 200. In detail, the input unit 210 includes the first speaker units 211 and 212 and the receiver 213, which are incorporated in the mobile device 100 and output a sound generated in the mobile device 100, the first microphone 214 which is incorporated in the mobile device 100, receives a user's voice signal, and inputs the voice signal to the sound input and output extending apparatus 200, and a second microphone 215 which is installed outside the mobile device 100, receives a background sound from the user's background, and inputs the sound to the sound input and output extending apparatus 200. The first speaker units 211 and 212, the receiver 213, and the first microphone 214 are electrically connected to the codec 220. The codec 220 is connected to the input unit 210, converts a sound received through the input unit 210 into a digital signal, and converts the digital signal into a sound signal.

The output unit 230 receives the sound signal from the codec 220 and outputs the sound signal via second speaker units 231 and 232.

The control unit 240 controls the input unit 210, the codec 220, and the output unit 230 and processes the sound signal.

The interface unit 250, which is controlled by the control unit 240, is connected to the mobile device 100 via a data communication interface, and transmits a sound signal processed by the control unit 240 or a given signal-processing result signal to the mobile device 100 or receives the sound signal processed by the control unit 240 or the given signal-processing result signal from the mobile device 100.

The data storage unit 260 is connected to the control unit 240 and stores data regarding the sound signal processed by the control unit 240.

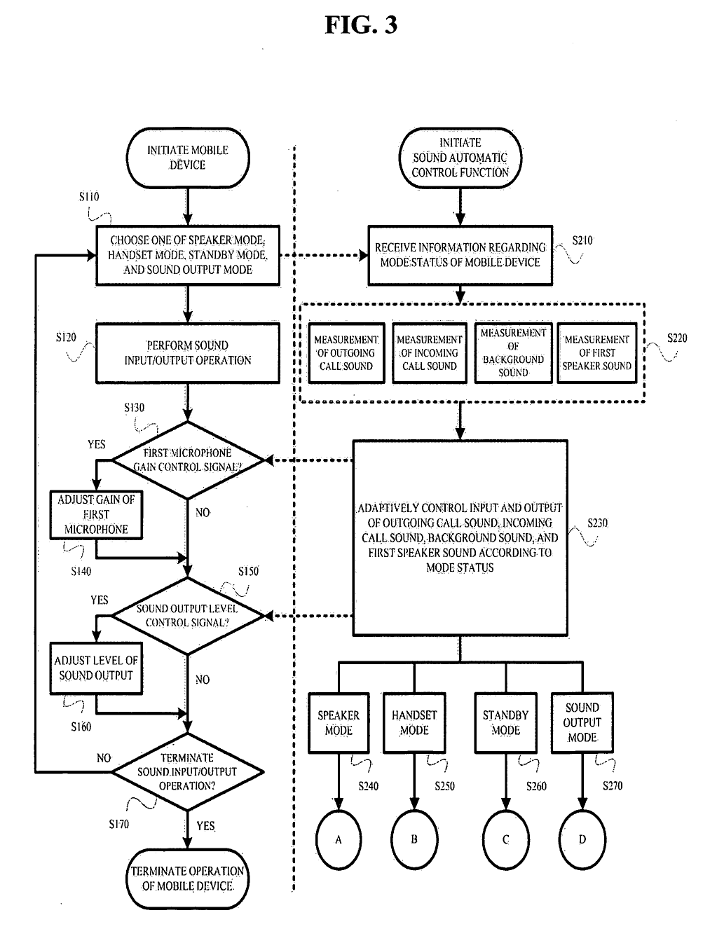

An operation of the sound input and output extending apparatus 200 will now be described in detail with reference to FIGS. 3 through 6.

FIG. 3 is a flowchart of a method of extending sound input and output according to an exemplary embodiment of the present invention.

The left part of FIG. 3 illustrates an operation of the mobile device 100, and the right part of FIG. 3 illustrates an operation of the sound input and output extending apparatus 200. These parts are separated by the vertical hashed line of FIG. 3.

Referring to FIGS. 2 and 3, first, in operation S110, one of four modes, i.e., a speaker mode, a handset mode, a standby mode, and a sound output mode, is chosen as a mode status of the mobile device 100. In operation S210, the control unit 240 of the sound input and output extending apparatus 200 receives information regarding the chosen mode via the interface unit 250. In operation S220, the control unit 240 receives an outgoing-call sound from the first microphone 214, receives an incoming-call sound from the receiver 213, receives a background sound of the sound input and output extending apparatus 200, receives a first speaker sound generated by the mobile device 100, and measures the outgoing-call sound, the incoming-call sound, the background sound, and the first speaker sound. In operation S230, the control unit adaptively controls the outgoing-call sound, the incoming-call sound, the background sound, the first speaker sound according to the chosen mode, processes the outgoing-call sound, the incoming-call sound, the background sound, the first speaker sound, or extract specific information. The results of the operation performed by the control unit 240 in operation S230 are transmitted to the processor 120 of the mobile device 100.

In operation S120, once one of the four modes is chosen as the mode status of the mobile device 100, the mobile device 100 begins to perform a sound input/output operation in the chosen mode. In operation S130, if a control signal is applied to the mobile device 100 in operation S230, the processor 120 of the mobile device 100 determines whether the control signal is a gain control signal for controlling the gain of the first microphone 214. In operation S140, if the control signal is determined in operation S130 as being a gain control signal for controlling the gain of the first microphone 214, the processor 120 adjusts the gain of the first microphone 214. In operation S150, if the control signal is determined in operation S130 as not being a gain control signal for controlling the gain of the first microphone 214 or after operation S140, the processor 120 determines whether the control signal is a sound output level control signal. In operation S160, if the control signal is determined in operation S150 as being a sound output level control signal, the processor 120 adjusts a sound output level. In operation S170, if the control signal is determined in operation S150 as not being a sound output level control signal or after operation S160, the processor 120 determines whether to terminate the sound input/output operation. If the processor 120 decides to terminate the sound input/output operation, the operation of the method is terminated. Conversely, if the processor 120 decides not to terminate the sound input/output operation, the method returns to operation S110.

As described above, in operation S230, the control unit controls the outgoing-call sound, the incoming-call sound, the background sound, the first speaker sound according to the chosen mode, and transmits the results of the controlling to the processor 120 of the mobile device 100.

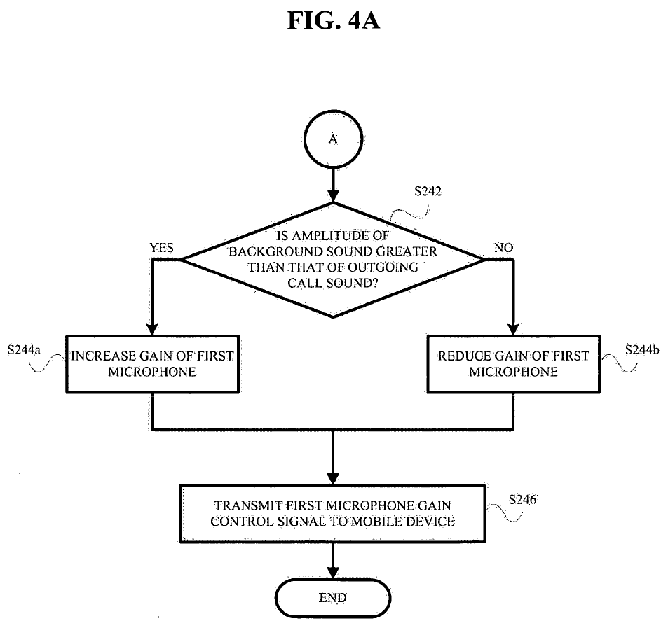

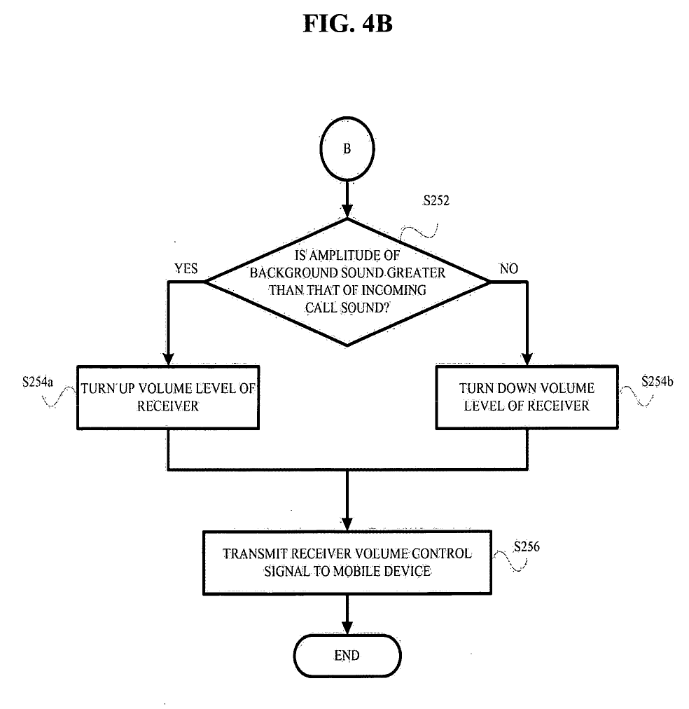

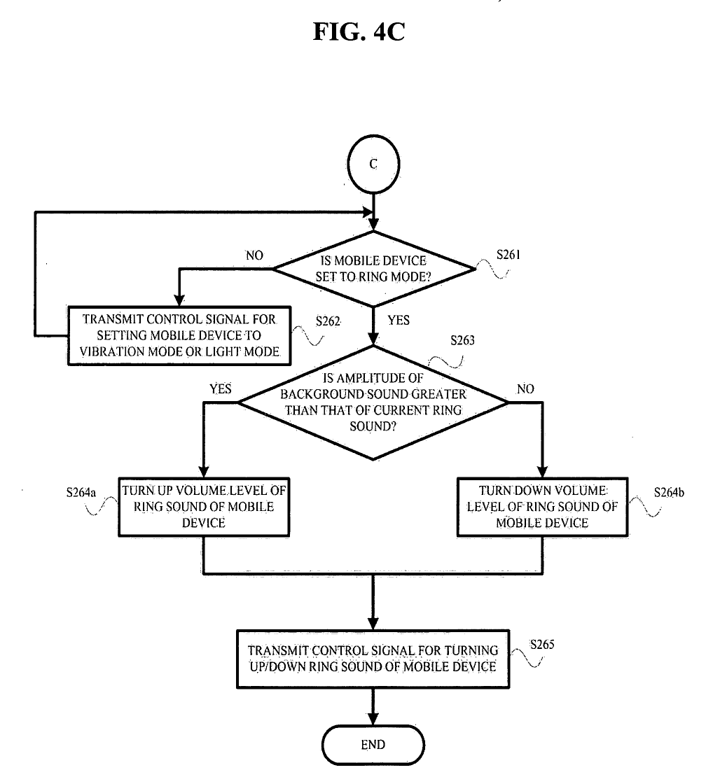

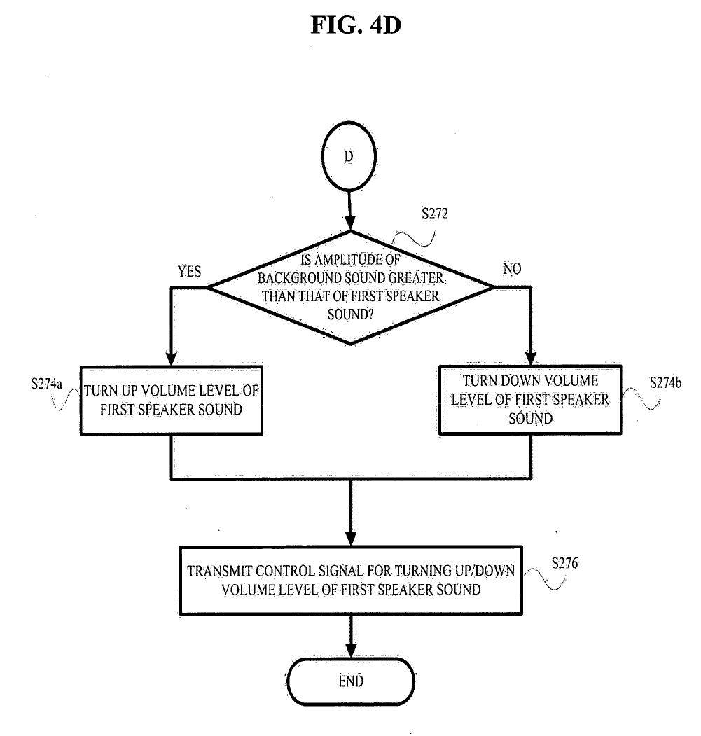

Operation S230 will now be described in detail with reference to FIGS. 4A through 4D.

FIGS. 4A through 4D are flow diagrams illustrating a control procedure in a method of extending sound input and output according to an embodiment of the present invention;

First, referring to FIG. 4A, in operation S242, if the chosen mode is the speaker mode, labeled S240 in FIG. 3, an amplitude of the outgoing-call sound is compared with an amplitude of the background sound. In operation S244b, if the amplitude of the outgoing-call sound is greater than the amplitude of the background sound, the gain of the first microphone 214 is increased. Conversely, in operation S244a, if the amplitude of the background sound is greater than the amplitude of the outgoing-call sound, the gain of the first microphone 214 is reduced. In operation S246, a microphone gain control signal for increasing or reducing the gain of the first microphone 214 is transmitted to the mobile device 100 via the interface unit 250.

Referring to FIG. 4B, in operation S252, if the chosen mode is the handset mode, labeled S250 in FIG. 3, the amplitude of the incoming-call sound is compared with the amplitude of the background sound. In operation S254a, if the amplitude of the background sound is greater than the amplitude of the incoming-call sound, a volume level of the receiver 213 is turned up. Conversely, in operation S254b, if the amplitude of the incoming-call sound is greater than the amplitude of the background sound, the volume level of the receiver 213 is turned down. In operation S256, a control signal for controlling a volume level of the receiver 213 to be turned up or down is transmitted to the mobile device 100 via the interface unit 250.

The standby mode, labeled S260 in FIG. 3, will be described in detail referring to FIG. 4C. In operation S261, it is determined whether the mobile device 100 is in a ring mode or not. If not, a control signal for setting the mobile device 100 in a vibration mode or a light mode is transmitted to the mobile device 100 via the interface unit 250 in operation S262 and operation S261 is repeated. Conversely, in operation S263, if the mobile device 100 is set to the ring mode in operation S261, a current ring sound of the mobile device 100 is compared with the background sound. If the amplitude of the background sound is greater than the amplitude of the current ring sound, a volume level of the ring sound of the mobile device 100 is turned up in operation S264a. Conversely, in operation S264b, if the amplitude of the current ring sound is greater than the amplitude of the background sound, the volume level of the ring sound of the mobile device 100 is turned down. Thereafter, a control signal for turning up or down the volume level of the ring sound of the mobile device 100 is transmitted to the mobile device 100 via the interface unit 250.

Referring to FIG. 4D, in operation S272, if the chosen mode is the sound output mode, labeled S270 in FIG. 3, the amplitude of the background sound is compared with that of the first speaker sound. In operation S274a, if the amplitude of the background sound is greater than the amplitude of the first speaker sound, the volume level of the first speaker units 211 and 212 is turned up. Conversely, in operation S274b, if the amplitude of the first speaker sound is greater than the amplitude of the background sound, the volume levels of the first speaker units 211 and 212 are turned down. Thereafter, in operation S276, a control signal for controlling volume levels of the first speaker units 211 and 212 to be turned up and down is transmitted to the mobile device 100 via the interface unit 250.

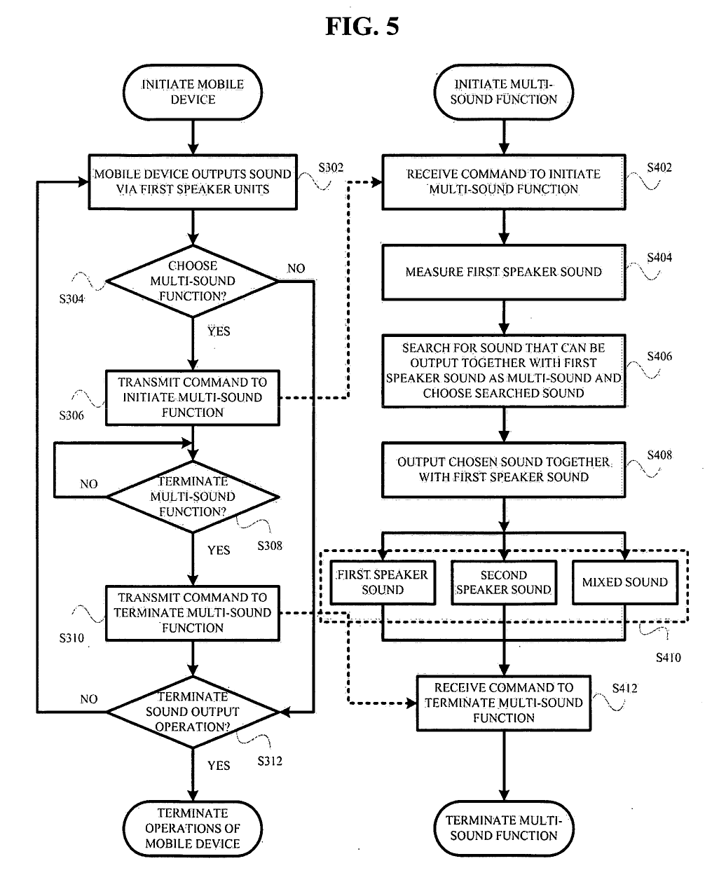

FIG. 5 is a flowchart illustrating a method of extending sound input and output according to another embodiment of the present invention. The left part of FIG. 5 illustrates an operation of the mobile device 100, and the right part of FIG. 5 illustrates an operation of the sound input and output extending apparatus 200. These parts are separated by the vertical hashed line of FIG. 3.

Referring to the method of FIG. 5, in operation S302, the mobile device 100 outputs sounds via the first speaker units 211 and 212. In operation S304, a user decides whether to choose a multi-sound function. A first speaker sound, which is a sound output from the first speaker units 211 and 212, may be MP3 music, and the multi-sound function may be a beatbox function.

If the user decides not to choose the multi-sound function, the method proceeds to operation S312. In operation S312, the user decides whether to terminate the operation of the method. Conversely, in operation S306, if the user decides to choose the multi-sound function, the control unit 240 of the sound input and output extending apparatus 200 receives a command to initiate the multi-sound function from the mobile device 100 via the interface unit 250 in operation S402. In operation S404, the control unit 240 measures a first speaker sound output from the first speaker units 211 and 212 of the mobile device 100.

In operation S406, in order to provide a beatbox sound and harmony, and thus output the first speaker sound as a multi-sound, the control unit 240 searches for a sound which can be output together with the first speaker sound and chooses the searched sound. In operation S408, the chosen sound is output together with the first speaker sound. The chosen sound may be output in various manners. For example, the chosen sound may be output via the second speaker units 231 and 232 of the sound input and output extending apparatus 200, via the first speaker units 211 and 212 of the mobile device 100, or via both the first speaker units 211 and 212 and the second speaker units 231 and 232. Alternatively, in operation S410, the chosen sound may be mixed with the first speaker sound, and a mixed sound is output. In operation S410, the chosen sound may be mixed with the first speaker sound using a hardware mixing method or a software mixing method.

After the mobile device 100 transmits the command to initiate the multi-sound function to the sound input and output extending apparatus 200 via the interface unit 250 (in operation S306), the user decides whether to terminate the multi-sound function. In operation S310, if the user decides to terminate the multi-sound function, the mobile device 100 transmits a command to terminate the multi-sound function to the sound input and output extending apparatus 200 via the interface unit 250. In operation S412, the control unit 240 receives the command to terminate the multi-sound function from the mobile device 100 via the interface unit 250. Then, the multi-sound function of the mobile device 100 is terminated. Once the mobile device 100 transmits the command to terminate the multi-sound function to the sound input and output extending apparatus 200 (in operation S310), the user decides whether to terminate the output operation of the first speaker sound in operation S312. If the user decides to terminate the output operation of the first speaker sound, no sound is output from the first speaker units 211 and 212 any longer. Conversely, if the user decides not to terminate the output operation of the first speaker sound, the method returns to operation S302.

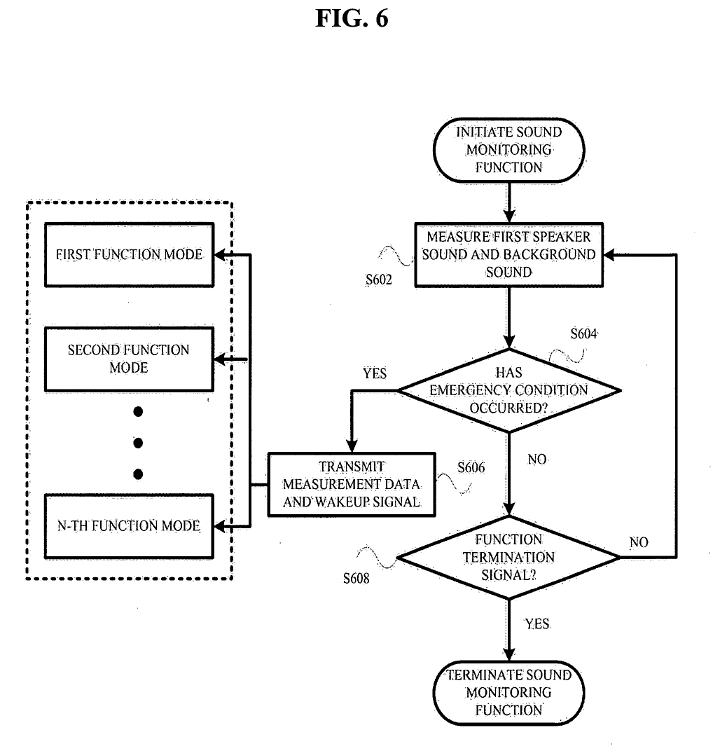

FIG. 6 is a flowchart illustrating a method of extending sound input and output according to another exemplary embodiment of the present invention. In the method illustrated in FIG. 6, the sound input and output extending apparatus 200 can monitor the mobile device 100 regardless of a current mode status of the mobile device. In other words, regardless of whether the mobile device 100 is in a sleep state or a predetermined operation state and regardless of the states of a power supply and the processor 120 of the mobile device 100, the sound input and output extending apparatus 200 can periodically or continuously monitor and record a sound output from the mobile device 100, the user's voice, and a background sound from the user's background, and additionally process them.

Referring to FIG. 6, in operation S602, the sound input and output extending apparatus 200 measures a first speaker sound which is generated by the mobile device 100 and is output from the first speaker units 211 and 212, the user's voice which is input to the sound input and output extending apparatus 200 by the first microphone 214, and a background sound which is input to the sound input and output extending apparatus 200 by the second microphone 215. In operation S604, the control unit 240 of the sound input and output extending apparatus 200 determines whether an emergency condition has occurred based on the measuring result. Examples of the emergency condition include a case when a loud sound is input to the sound input and output extending apparatus 200 by the second microphone 215 as the background sound, for example, when the user accidentally drops the mobile device 100, when the user screams for help in an emergency, or when the user moves from a silent place to a noisy place; and a case when the user speaks a predetermined voice command out loud so that the predetermined voice command can be input to the sound input and output extending apparatus 200 by the first microphone 214.

In operation S606, if it is determined in operation S604 that the emergency condition has occurred, data regarding the first speaker sound, the user's voice, and the background sound measured by the sound input and output extending apparatus 200 and a wakeup signal are transmitted to the mobile device 100. At this time, the data and the wakeup signal are transmitted to the mobile device 100 in the corresponding modes, respectively. That is, even if the mobile device 100 is in a standby mode or a sleep mode, it can be activated by the wakeup signal.

In other words, once the mobile device 100 receives the data and the wakeup signal transmitted by the sound input and output extending apparatus 200, the mobile device 100 outputs a signal indicating that the emergency condition has occurred regardless of a mode status of the mobile device 100. Here, the signal indicating that the emergency condition has occurred may be indicated via the first speaker units 211 and 212, via the second speaker units 231 and 232, or via both the first speaker units 211 and 212 and the second speaker units 231 and 232. Alternatively, the signal indicating that the emergency condition has occurred may be indicated via a variety of user interfaces such as an LCD screen, a vibration motor, or an LED.

The sound emitted by the mobile device 100 may be a sound signal that a user previously transmitted to the mobile device 100 or an outgoing call signal that a user previously transmitted to another mobile device other than the mobile device 100.

The sound input and output extending apparatus 200 may choose and use a sampling method and an encoding method regardless of the types of a sampling method and an encoding method used by the codec 124 in the mobile device 100. For example, even though the codec 124 of the mobile device 100 an 8-bit, 8 kHz sampling method and an adaptive differential pulse code modulation (ADPCM) encoding method, the codec 200 of the sound input and output extending apparatus 200 can perform a 16-bit, 16 kHz sampling operation and a pulse code modulation (PCM) encoding operation independently of the mobile device 100. Therefore, the sound input and output extending apparatus 200 can perform an encoding operation independently of an encoding operation performed by the mobile device 100. Thus, the control unit 240 of the sound input and output extending apparatus 200 can guarantee high-quality sound processing performance, and the data storage unit 260 of the sound input and output extending apparatus 200 can store high-quality sound data.

In operation 608, if it is not determined in operation 604 that an emergency condition has occurred, it is determined whether a function termination signal is received. If a function termination signal is received, the sound monitoring function is terminated. Conversely, if a function termination signal is not received, the process returns to operation S602.

According to the above-described embodiments of the present invention, all sounds generated in a mobile device can be sensed and processed by separately providing a control unit without modifying the construction of the mobile device.

In addition, according to the above-described embodiments of the present invention, multiple sound processing operations can be performed by independently processing a user's voice, a background noise, and sounds generated by a mobile device, which are generated via multiple sound paths, and adding the processing results to the original sounds to then output a new sound.

Further, device-dependent sound processing operations, according to the above-described embodiments of the present invention, a user's voice, a background sound generated and sounds generated by the mobile device itself are subjected to separate signal processing operations via separate sound paths, thereby realizing a wide variety of sound processing schemes.

Moreover, the embodiments of the invention can be implemented as a stand-alone sound input and output extending apparatus capable of sampling and processing sounds independent of whether a mobile device is being operated, thereby enabling sounds generated via multiple paths to be simultaneously processed without affecting nor being affected by the operations of the mobile device, and outputting specific sounds as the processing results. Likewise, according to the above-described embodiments of the present invention, sound and voice processing operations are independent of sampling and coding formats used by a mobile device, and, thus, it is possible to considerably enhance the performance of sound and voice processing.

Embodiments of the present invention include a program instruction capable of being executed via various computer units and may be recorded in a computer-readable storage medium. The computer-readable medium may include a program instruction, a data file, and a data structure, separately or cooperatively. The program instructions and the media may be those specially designed and constructed for the purposes of the present invention, or they may be of the kind well-known and available to those skilled in the art of computer software. Examples of the computer-readable media include magnetic media (e.g., hard disks, floppy disks, or magnetic tapes), optical media (e.g., CD-ROMs or DVD), magneto-optical media (e.g., optical disks), and hardware devices (e.g., ROMs, RAMs, or flash memories, etc.) that are specially configured to store and perform program instructions. The media may be transmission media such as optical or metallic lines, wave guides, etc. including a carrier wave transmitting signals specifying the program instructions, data structures, etc. examples of the program instructions include both machine code, such as produced by a compiler, and files containing high-level language codes that may be executed by the computer using an interpreter. The hardware elements above may be configured to act as one or more software modules for implementing the operations of this invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A sound input and output extending apparatus comprising:
an input unit that receives a sound;
a codec that converts the sound into a digital signal and converts the digital signal into a sound signal;
an output unit that outputs the sound signal via speaker units;
a control unit that processes the sound signal; and
an interface unit that is connected to a mobile device via a data communication interface and transmits the processed sound signal to the mobile device and receives the processed sound signal, both under the control of the control unit,
wherein the input unit includes first speaker units in the mobile device, and that output a sound generated by the mobile device, a receiver which outputs an incoming-call sound, a first microphone in the mobile device and that receives a user's voice signal, and a second microphone outside the mobile device and receives a background sound.

2. The apparatus of claim 1, further comprising a data storage unit which stores data regarding the processed sound signal.

3. A method of extending sound input and output in an apparatus in which a plurality of modes are settable and which is connected to a mobile device that is switchable between each of the plurality of modes, the method comprising:
receiving from the mobile device information regarding a mode status of the mobile device;
receiving and measuring an outgoing-call sound received through a first microphone, an incoming-call sound that is output by a receiver, a background sound that is received via a second microphone, and a sound that is generated by the mobile device and output by first speaker units according to the received information regarding the mode status of the mobile device; and
adaptively controlling the outgoing-call sound, the incoming-call sound, the background sound, and the first speaker sound according to the received information regarding the mode status based on the measured result.

4. The method of claim 3, wherein the received mode includes a speaker mode, a handset mode, a standby mode, and a sound output mode.

5. The method of claim 4, wherein, when the mode is the speaker mode, the controlling comprises:
comparing an amplitude of the outgoing-call sound with that of the background sound; and
increasing the gain of the first microphone when the amplitude of the background sound is greater than the amplitude of the outgoing-call sound, and reducing the gain of the first microphone when the amplitude of the outgoing-call sound is greater than the amplitude of the background sound.

6. The method of claim 4, wherein, when the mode is the handset mode, the controlling comprises:
comparing an amplitude of the background sound with that of the incoming-call sound; and
turning up the volume level of the receiver when the amplitude of the background sound is greater than the amplitude of the incoming-call sound, and turning down the volume level of the receiver when the amplitude of the incoming-call sound is greater than the amplitude of the background sound.

7. The method of claim 4, wherein, when the mode is the standby mode, the controlling comprises:
determining whether the mobile device is set to a ring mode; and
comparing an amplitude of the ring sound of the mobile device with an amplitude of the background sound, when the mobile device is set to the ring mode, turning up the ring sound of the mobile device when the amplitude of the background sound is greater than the amplitude of the a current ring sound, and turning down the ring sound of the mobile device when the current ring sound is greater than the amplitude of the background sound; and
transmitting, when the mobile device is not set to the ring mode, a control signal for setting the mobile device to a vibration mode or a light mode.

8. The method of claim 4, wherein, when the mode is the sound output mode, the controlling comprises:
comparing the amplitude of the background sound with that of the first speaker sound; and
turning up the volume level of the sound of the first speaker units when the amplitude of the background sound is greater than the amplitude of the first speaker sound, and turning down the volume level of the first speaker units when the amplitude of the first speaker sound is greater than the amplitude of the background sound.

9. A method of extending sound input and output in an apparatus connected to a mobile device which outputs sounds via first speaker units, the method comprising:
receiving a command to initiate a multi-sound function from the mobile device;
measuring a first speaker sound output by the mobile device;
searching for a sound which can be output together with the first speaker sound, and choosing the found sound; and
outputting the chosen sound together with the first speaker sound.

10. The method of claim 9, wherein the outputting of the chosen sound includes:
outputting the chosen sound via second speaker units in the sound input and output extending apparatus;
outputting the chosen sound via the first speaker units; or
outputting the chosen sound via both the first speaker units and the second speaker units.

11. The method of extending sound input and output of claim 10, wherein the outputting the chosen sound includes mixing the chosen sound with the first speaker sound and outputting a mixed sound.

12. The method of extending sound input and output of claim 11, wherein the mixing includes mixing the chosen sound with the first speaker sound using hardware or software.

13. A method of extending sound input and output in an apparatus in which a plurality of modes are settable and which is connected to a mobile device that is switchable between each of the plurality of modes, the method comprising:
measuring an outgoing-call sound received through a first microphone, a first speaker sound generated by the mobile device, and a background sound received through a second microphone;
determining whether an emergency condition has occurred based on the measured result;
transmitting data regarding the outgoing-call sound, the first speaker sound, and the background sound and a wakeup signal for the mobile device to the mobile device, when it is determined that the emergency condition has occurred; and
causing the mobile device to output a signal indicating that the emergency condition has occurred.

14. The method of extending sound input and output of claim 13, wherein the signal indicating that the emergency condition has occurred includes a sound signal that a user previously set or an outgoing-call signal that a user previously sent to another mobile device.

15. The method of extending sound input and output of claim 14, wherein the sound signal set by the user is output via first speaker units incorporated in the mobile device, via second speaker units incorporated in the sound input and output extending apparatus, or via both the first speaker units and the second speaker units.

16. A computer-readable storage media encoded processing instructions for causing a processor to execute the method of claim 3.

17. A computer-readable storage media encoded processing instructions for causing a processor to execute the method of claim 9.

18. A computer-readable storage media encoded processing instructions for causing a processor to execute the method of claim 13.
